(19) United States
(12) Patent Application Publication
(10) Pub. No.: US 2004/0234112 A1
(43) Pub. Date: Nov. 25, 2004

(54) Apparatus for detecting fingerprints

(76) Inventors: Thorsten Boker, Beijing (CN); Peter Laackmann, Munchen (DE); Thomas Spottl, Regensburg (DE)

Correspondence Address: LERNER AND GREENBERG, P.A., POST OFFICE BOX 2480, HOLLYWOOD, FL, 33022-2480, US

(21) Appl. No.: 10/657,601

(22) Filed: Sep. 8, 2003

Related U.S. Application Data
(63) Continuation of application No. PCT/DE02/00451, filed on Feb. 7, 2002.

(30) Foreign Application Priority Data
Mar. 8, 2001 (DE) 101 11 195.9

(51) Int. Cl. G06K 9/00

(52) U.S. Cl. 382/124

(57) ABSTRACT

An apparatus for detecting fingerprints having a reading unit for scanning a finger and an image processing unit. The image processing unit is connected to the reading unit and produces an image of the finger. A data interface based on a standard for changeable memory cards is provided and at least one portion of a housing of the apparatus has the housing shape for memory cards based on this standard.

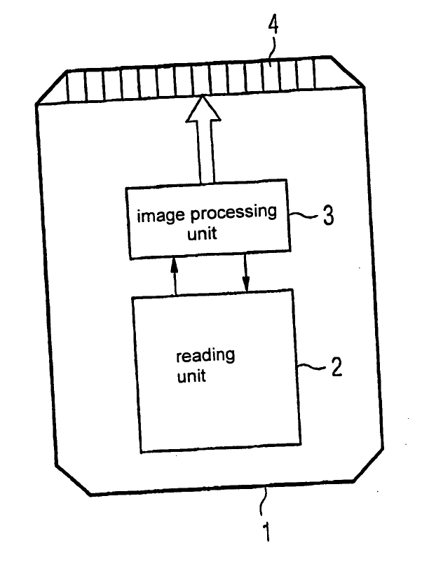

### CROSS-REFERENCE TO RELATED APPLICATION

This application is a continuation of copending International Application No. PCT/DE02/00451, filed Feb. 7, 2002, which designated the United States and was not published in English.

### BACKGROUND OF THE INVENTION

### FIELD OF THE INVENTION

The invention relates to an apparatus for detecting fingerprints having a reading unit for scanning a finger and an image processing unit, connected to the reading unit, for producing an image of the finger. Apparatuses of this kind are known in diverse forms for the purposes of authenticating authorized use. In this regard, an evaluation unit additionally needs to be provided which compares the fingerprint that is read with prescribed patterns in order thus to be able to establish whether the currently read fingerprint belongs to a user who is authorized to use the system.

If a fingerprint sensor is intended to be incorporated into an existing appliance, for example in a mobile telephone, a portable computer (i.e. a “notebook”), or the like, then an additional interface needs to be provided for this sensor. In addition, the sensor needs to be mechanically incorporated into the housing, which means that changes need to be made in this regard too. Furthermore, the recording of a fingerprint image from the data delivered by a sensor requires special software for driving the sensor, and this special software needs to be provided or developed in addition. Overall, the additional incorporation of a biometric fingerprint sensor into an existing appliance signifies a high level of development complexity.

### SUMMARY OF THE INVENTION

It is accordingly an object of the invention to provide an apparatus for detecting fingerprints that overcomes the hereinafore-mentioned disadvantages of the heretofore-known devices of this general type and that allows subsequent incorporation of an apparatus for detecting fingerprints into an otherwise existing appliance without this representing a high level of additional complexity, which means that it is also beneficial from the point of view of cost.

With the foregoing and other objects in view, there is provided, in accordance with the invention, an apparatus for detecting fingerprints. The apparatus includes a reading unit, an image processing unit, a data interface, and a housing. The reading unit is used for scanning a finger. The image processing unit connects to the reading unit and produces an image of the finger. The data interface is connected to the image processing unit and is based on a standard for changeable memory cards holding large volumes of data. The housing holds the reading unit and the image processing unit and has a portion with a housing shape for receiving the changeable memory cards based on the standard.

In other words, the object is achieved by an apparatus of the type mentioned in the introduction for detecting fingerprints which is characterized in that a data interface based on a standard for changeable memory cards is provided for holding large volumes of data., and at least one portion of a housing of the apparatus has the housing shape for memory cards based on this standard.

The inventive apparatus has the advantage that the form of the data interface and the housing shape based on an already existing standard for memory cards mean that it can be operated with appliances that are provided for communication with such memory cards. Thus, by way of example, there are mobile telephones which are equipped with interfaces for a “multimedia card” (MMC) in order to allow the mobile telephone to be used as a playback appliance for MP3 files. This interface, which is provided anyway, can now have the inventive apparatus for detecting fingerprints connected to it, so that the already existing mobile telephone can be extended with the authentication function of a fingerprint sensor. From the point of view of the appliance, a fingerprint is read in the same way as a normal, stored image is read. Only by adapting the software for the appliance is the extension to authenticating a user by the fingerprint made by the user.

The invention thus combines the data and interface format, the pin assignment and the physical dimensions of a memory card with the functionality of a biometric fingerprint sensor. With regard to the housing shape, it is often sufficient for the housing portion provided for accommodation in the appliance to correspond to the memory card standard. It would also be possible to provide an adapter which connects a fingerprint sensor, supplying data in the format provided on the basis of the interface specifications, to the appliance and which satisfies the appropriate requirements in terms of the housing shape and the contacts.

One advantage is that the memory card interfaces provided on the appliance comply with the requirements of a fingerprint sensor. By way of example, in the case of a memory card for a digital camera, large volumes of image data need to be transferred in a short time. This capability is also required for transferring the image file containing the fingerprint.

If the relevant terminal already has a memory card slot, then no kind of further changes to the hardware are required in order to incorporate a fingerprint sensor. The fingerprint is simply read like an image stored on a normal memory card.

If the terminal does not yet have a slot for a memory card, then the additionally required hardware complexity is comparatively low, since the necessary hardware components for memory cards are very inexpensive as a result of large-scale production, and the additional development complexity is very low due to example applications and fabrication models. A particularly suitable standard is the multimedia card standard.

In another advantageous development, the image processing apparatus subjects a fingerprint that has been read to preprocessing and, by way of example, ascertains the minutiae of a fingerprint. This relieves the load on the appliance, which now merely has to compare the minutiae read in with stored user data in order thereby to perform user authentication.

In accordance with a further object of the invention, the standard utilizes memory cards that can store large volumes of data. For purposes of the application, “large” volumes are volumes of at least one megabyte. Furthermore, even though the volumes can be at least one megabyte (or large), does not preclude the inclusion of volumes that are smaller than one megabyte.

Other features that are considered as characteristic for the invention are set forth in the appended claims.

Although the invention is illustrated and described herein as embodied in an apparatus for detecting fingerprints, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWINGS

The FIGURE is a partially diagrammatic and partially schematic plan view showing an apparatus according to the invention for detecting fingerprints.

### DESCRIPTION OF THE PREFERRED EMBODIMENTS

Referring now to the single FIGURE of the drawing, an apparatus for detecting fingerprints 1 has a reading unit 2 for scanning a finger and an image processing unit 3, connected to the reading unit 2 for producing an image of the finger. The image processing unit 3 optimizes the images of the finger and drives the reading unit as appropriate. Similarly, data compression and distortion tests can be carried out by the image processing unit 3. The image processing unit 3 also ensures that the data are provided in a format that corresponds to the data format of the memory cards based on the standard. Similarly, the physical data transfer is controlled as appropriate by the contacts 4. The image processing unit 3 is coordinated with a transfer protocol using a terminal.

In another embodiment, the additional functions such as data compression, contrast enhancement, distortion tests etc. are not carried out by the image processing unit 3, but rather by a connected appliance.

In the case of a ROM multimedia card or FLASH multimedia card, there is a real file system that manages the memory area. In the case of the apparatus according to the invention, this file system is simulated. For the interface of the terminal, it thus makes no difference whether a file is read from a memory card or whether the image that is read comes from a fingerprint sensor.

To extend an existing terminal by an inventive apparatus for detecting fingerprints, the terminal's interface merely needs to be provided such that the fingerprint sensor can be reached by a finger. Alternatively, provision could be made, by way of example, for the inventive apparatus to be inserted and for the terminal then to put the apparatus into a state that allows fingerprints to be read, with the apparatus being withdrawn again in order to apply the finger. The apparatus can then be inserted again within a limited time, which then allows the terminal to read in the image data for the fingerprint.

Other changes on the terminal relate only to the software, which means no great complexity from a technical point of view, however, since appropriate programs and program modules already exist from other applications.

In the apparatus for detecting fingerprints, the image processing unit 3 is connected to the electrical contacts 4 and outputs the data which are read on the electrical contacts in line with the interface specifications.

The reading unit has been described in such a way, and is also shown in the FIGURE in such a way, that the whole relevant finger area can be applied. For reasons of cost, however, it may appear more beneficial to provide only a strip sensor and to move the finger across this strip in order thus to obtain an entire fingerprint after image portions have been assembled. This option is naturally also included in the invention.

We claim:

1. An apparatus for detecting fingerprints, comprising:
a reading unit for scanning a finger;
an image processing unit connected to said reading unit for producing an image of the finger;
a data interface connected to said image processing unit and being based on a standard for changeable memory cards holding large volumes of data; and
a housing holding said reading unit and said image processing unit and having a portion with: a housing shape for receiving the changeable memory cards.

2. The apparatus according to claim 1, wherein the standard is a multimedia card standard.

3. The apparatus according to claim 1, wherein said image processing unit produces data readable by a reader for the memory cards.

4. The apparatus according to claim 2, wherein said image processing unit produces data readable by a reader for the memory cards and conforming to the multimedia card standard.

5. The apparatus according to claim 1, wherein said image processing unit is configured to ascertain minutiae of a recorded image of the finger and to read the minutiae via said data interface.

6. The apparatus according to claim 1, wherein each of the volumes of data holdable on the memory cards is large.

7. The apparatus according to claim 1, wherein each of the volumes of data holdable on the memory cards is at least one megabyte.
